(19) United States
(12) Patent Application Publication
(10) Pub. No.: US 2026/0303573 A1
(43) Pub. Date: Oct. 1, 2026

(54) Secure Communication between a Client Device and a Server Device via a Gateway

(71) Applicant: Telefonaktiebolaget LM Ericsson (publ), Stockholm (SE)

(72) Inventors: Bernard Smeets, Dalby (SE); Alexander Maximov, Lund (SE)

(21) Appl. No.: 19/479,458

(22) PCT Filed: Jun. 8, 2023
(86) PCT No.: PCT/EP2023/065352

§ 371 Date: Oct. 28, 2025

(51) Int. Cl. H04L 9/40

(52) U.S. Cl. CPC H04L 63/0281; H04L 63/0428

(57) ABSTRACT

There is provided techniques for secure communication between a client device and a server device. A method is performed by a gateway The gateway is operatively connected between the client device and the server device. The method comprises establishing a first secure link with the client device at a first socket and a second secure link with the server device at a second socket. The gateway holds a second link context for the first secure link at the first socket and a third link context for the second secure link at the second socket. The method comprises sending a part of the second link context to the server device over the second secure link. The method comprises relaying encrypted packets between the client device and the server device without decrypting or encrypting the encrypted packets at the first socket or the second socket.

### TECHNICAL FIELD

Embodiments presented herein relate to methods, a gateway, a server device, computer programs, and a computer program product for secure communication between a client device and a server device.

### BACKGROUND

In general terms, realization of secure communication implementation in large systems often involves the use of gateways, ingress controllers, and/or proxies. Such entities are provided to give external client devices the ability to access services as provided by server devices in the system whilst protecting the actual server devices. This can be achieved by the gateways not exposing the server devices directly to the client devices and to use multiple server devices, or server instances, for load balancing and increased availability (i.e., high-availability setup) behind the gateway. Security can be realized by using Transport Layer Security (TLS), or Hypertext Transfer Protocol Secure (HTTPS) which is using TLS as a sub-protocol, or other protocols, e.g., QUIC.

Assume therefore a network architecture where multiple services are running on server devices implemented in a computational cloud, and where client devices external to the server devices request access to these services through a gateway. In such a network architecture the gateway could be the only network point exposed (directly reachable) to the external client devices whilst keeping the internal network where the server devices are provided unexposed. The gateway might therefore be responsible for authorizing the client devices before they gain access to any requested service, and then relaying communication between the client devices and the server device on which the service is running. Additionally, the gateway might be configured to balance the load of server devices.

One possible way of the network operation based on the above principles is illustrated in FIG. 1. In FIG. 1 is illustrated a system 10 comprising a client device (C), a gateway (G) and three server devices (Srv1, Srv2, Srv3). The server devices are provided in an internal network. Access to the internal network in general, and to services(S) as provided by the server devices in particular, is facilitated by the gateway. The gateway is thus operatively connected between the client device and the three server devices.

As a first step, in order to access a service provided by one or more of the server devices, the client device connects to the gateway, and the first secure TLS link (L12) is established by means of a handshake procedure. The handshake procedure might also use certificates or any other means. When the TLS link is realized, the server-client endpoints hold a TLS protocol context. Related to the link L12, the client device holds its own TLS protocol context E1 and the gateway holds the TLS protocol context E2.

As the next step, the client device sends a request message to connect to a certain service(S). The gateway reads that message and determines the location of an appropriate server device (in the present example the server device denoted Srv3) that can deliver the requested service. In some examples, the gateway may additionally determine the least occupied service pod in the computational cloud, if necessary (e.g., for load balancing), assuming that the requested service is available at multiple pods and/or server devices. The gateway subsequently connects to the selected server device and thus establishes a second secure TLS link (L34) to that server device. There may be yet another handshake procedure required (which may differ from the type of the first handshake for the first link L12) to secure the link L34 between the gateway and the server device. In relation to the link L34, the gateway holds the TLS protocol context E3 and the server holds the TLS protocol context E4.

It is understood that a TLS context (e.g., E1-E4) might comprise many data fields (such as data fields related to secret keys, certificates, states of algorithms, etc)., but that each TLS context is associated with, and built on top of, an underlaying socket (referred to as e.g., “E1.socket”). This socket can be regarded as the data object that is associated with the lower layer protocol of the network link (e.g., TCP/IP), and is partly handled by the Operating System (OS) and hardware, including sending and receiving raw bytes over the physical network.

After the two links L12 and L34 have been established and secured, the client device is enabled to communicate with the selected server device Srv3 for accessing the services S, whilst the gateway acts as a relay point of data between E2 and E3. That is, there is in fact no end-to-end connection between the client device and the server device but rather a hop-to-hop link.

One issue with the described network architecture is that the gateway has to re-encrypt all messages exchanged between the client device and the server device, to be more precise, between E2 and E3. This effectively slows down the communication by around two times and increases latency. Further, since the gateway is the single point of entry for all client devices, it becomes a bottleneck for all communications with the server devices.

In this respect, in the technical field of cloud computing, Endpoint Detection and Response (EDR) tools are provided to collect information of the applications that are running. Mostly these EDR tools are used for monitoring purposes, but such tools can also be used to extract the clear text data and thus feed the clear text out from the application into the infrastructure provider's domain. If the data then is sent further it might be encrypted again. However, although it might seem that EDR tools decrypt TLS, this is not the case. Rather, the clear text is extracted after decryption (or, alternatively, before its encryption). Hence, EDR tools cannot be used to relieve the gateway from decrypting messages to be passed between E2 and E3 and then encrypting these messages again.

Hence, there is still a need for improved secure communication between the client device and the server device, in particularly with respect to latency.

### SUMMARY

An object of embodiments herein is to address the above issues to provide efficient secure communication between a client device and a server device.

A particular object is to provide techniques that enable the latency at the gateway to be reduced.

A particular object is to provide techniques that enable the load at the gateway to be reduced.

A particular object is to provide techniques that allow the need for decryption and encryption at the gateway to be removed when relaying messages between the client device and the server device.

According to a first aspect there is presented a method for secure communication between a client device and a server device. The method is performed by a gateway. The gateway is operatively connected between the client device and the server device. The method comprises establishing a first secure link with the client device at a first socket and a second secure link with the server device at a second socket. The gateway holds a second link context for the first secure link at the first socket and a third link context for the second secure link at the second socket. The method comprises sending a part of the second link context to the server device over the second secure link. The method comprises relaying encrypted packets between the client device and the server device without decrypting or encrypting the encrypted packets at the first socket or the second socket.

According to a second aspect there is presented a gateway for secure communication between a client device and a server device. The gateway is configured to be operatively connected between the client device and the server device. The gateway comprises processing circuitry. The processing circuitry is configured to cause the gateway to establish a second secure link with the gateway. The server device holds a fourth link context for the second secure link. The processing circuitry is configured to cause the gateway to receive, from the gateway and over the second secure link, a part of a second link context for a first secure link established between the gateway and the client device. The processing circuitry is configured to cause the gateway to communicate packets with the client device over the second secure link with the received part of the second link context replacing a matching part of the fourth link context for encrypting and decrypting the packets.

According to a third aspect there is presented a gateway for secure communication between a client device and a server device. The gateway is configured to be operatively connected between the client device and the server device. The gateway comprises an establish module configured to establish a second secure link with the gateway. The server device holds a fourth link context for the second secure link. The gateway comprises a receive module configured to receive, from the gateway and over the second secure link, a part of a second link context for a first secure link established between the gateway and the client device. The gateway comprises a communicate module configured to communicate packets with the client device over the second secure link with the received part of the second link context replacing a matching part of the fourth link context for encrypting and decrypting the packets.

According to a fourth aspect there is presented a computer program for secure communication between a client device and a server device. The computer program comprises computer code which, when run on processing circuitry of a gateway, causes the gateway to perform actions. The gateway is configured to be operatively connected between the client device and the server device. One action comprises the gateway to establish a second secure link with the gateway. The server device holds a fourth link context for the second secure link. One action comprises the gateway to receive, from the gateway and over the second secure link, a part of a second link context for a first secure link established between the gateway and the client device. One action comprises the gateway to communicate packets with the client device over the second secure link with the received part of the second link context replacing a matching part of the fourth link context for encrypting and decrypting the packets.

According to a fifth aspect there is presented a method for secure communication between a client device and a server device. The method is performed by the server device. The server device is operatively connected to a gateway. The method comprises establishing a second secure link with the gateway. The server device holds a fourth link context for the second secure link. The method comprises receiving, from the gateway and over the second secure link, a part of a second link context for a first secure link established between the gateway and the client device. The method comprises communicating packets with the client device over the second secure link with the received part of the second link context replacing a matching part of the fourth link context for encrypting and decrypting the packets.

According to a sixth aspect there is presented a server device for secure communication with a client device. The server device is configured to be operatively connected to a gateway. The server device comprises processing circuitry. The processing circuitry is configured to cause the server device to establish a first secure link with the client device at a first socket and a second secure link with the server device at a second socket. The gateway holds a second link context for the first secure link at the first socket and a third link context for the second secure link at the second socket. The processing circuitry is configured to cause the server device to send a part of the second link context to the server device over the second secure link. The processing circuitry is configured to cause the server device to relay encrypted packets between the client device and the server device without decrypting or encrypting the encrypted packets at the first socket or the second socket.

According to a seventh aspect there is presented a server device for secure communication with a client device. The server device is configured to be operatively connected to a gateway. The server device comprises an establish module configured to establish a first secure link with the client device at a first socket and a second secure link with the server device at a second socket. The gateway holds a second link context for the first secure link at the first socket and a third link context for the second secure link at the second socket. The server device comprises a send module configured to send a part of the second link context to the server device over the second secure link. The server device comprises a relay module configured to relay encrypted packets between the client device and the server device without decrypting or encrypting the encrypted packets at the first socket or the second socket.

According to an eighth aspect there is presented a computer program for secure communication between a client device and a server device. The computer program comprises computer code which, when run on processing circuitry of a server device, causes the server device to perform actions. The server device is configured to be operatively connected to a gateway. One action comprises the server device to establish a first secure link with the client device at a first socket and a second secure link with the server device at a second socket. The gateway holds a second link context for the first secure link at the first socket and a third link context for the second secure link at the second socket. One action comprises the server device to send a part of the second link context to the server device over the second secure link. One action comprises the server device to relay encrypted packets between the client device and the server device without decrypting or encrypting the encrypted packets at the first socket or the second socket.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects preserve efficient secure communication between the client device and the server device.

Advantageously, these aspects enable the latency at the gateway to be reduced.

Advantageously, these aspects enable the load at the gateway to be reduced.

Advantageously, these aspects allow the need for decryption and encryption at the gateway to be removed when relaying messages between the client device and the server device.

Advantageously, these aspects enable messages to be exchanged between the client device and the server device faster than compared to the above procedure described with reference to FIG. 1, whilst maintaining the routing capability and load balancing. In some examples, the messages can be exchanged twice as fast.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a system according to embodiments;

FIGS. 2 and 3 are flowcharts of methods according to embodiments;

FIG. 4 is a signalling diagram of a method according to an embodiment;

FIG. 5 is a schematic diagram showing functional units of a gateway according to an embodiment;

FIG. 6 is a schematic diagram showing functional modules of a gateway according to an embodiment;

FIG. 7 is a schematic diagram showing functional units of a server device according to an embodiment;

FIG. 8 is a schematic diagram showing functional modules of a server device according to an embodiment; and

FIG. 9 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

As noted above, there is still a need for improved secure communication between the client device and the server device, in particularly with respect to latency.

The embodiments disclosed herein therefore relate to techniques for secure communication between a client device 100 and a server device 300. In order to obtain such techniques there is provided a gateway 200, a method performed by the gateway 200, a computer program product comprising code, for example in the form of a computer program, that when run on processing circuitry of the gateway 200, causes the gateway 200 to perform the method. In order to obtain such techniques, there is further provided a server device 300, a method performed by the server device 300, and a computer program product comprising code, for example in the form of a computer program, that when run on processing circuitry of the server device 300, causes the server device 300 to perform the method.

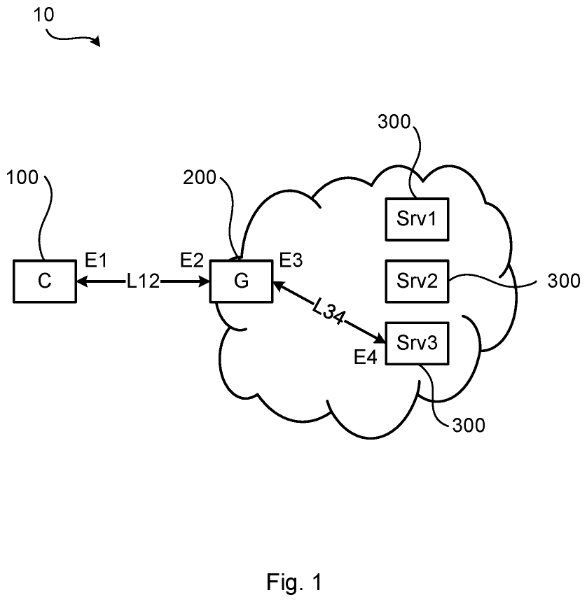

With reference again to FIG. 1, assume that the links L12 and L34 have been established as disclosed above, and that the relevant handshake procedures have been performed. Then, secure communication between the client device and the server device, in particularly with respect to latency, could be achieved if the need to decrypt incoming messages at E2 and E3 and encrypt outgoing messages at E2 and E3 was lifted. In this way, the gateway could simply relay raw (i.e., encrypted) TLS packets between E2 and E3. In order for this to be achieved, the gateway sends the whole or part of the context E2 (except for the E2.socket part) to the server device via the (already established and secured) channel L34. The server device then updates its own TLS context E4 (except for E4.socket) with the received (parts of) E2. This allows the gateway to relay raw TLS packets between E2.socket and E3.socket, without any need for decryption and re-encryption. That is, in this way, the decryption of the TLS packets sent by the client device will be performed at the server side. This might in some examples effectively double the speed of communication or reduces processing load by about 50%.

In other words, the gateway is first used to perform the server-side TLS handshake and to setup the context for the data decryption and encryption for incoming and outgoing traffic with respect to the server devices. The gateway then transfers part of its link context E2 of the secure link L12 to the server device running the service that the client device requests access to. Further, the server device changes its link context E4 in accordance with the received link context E2.

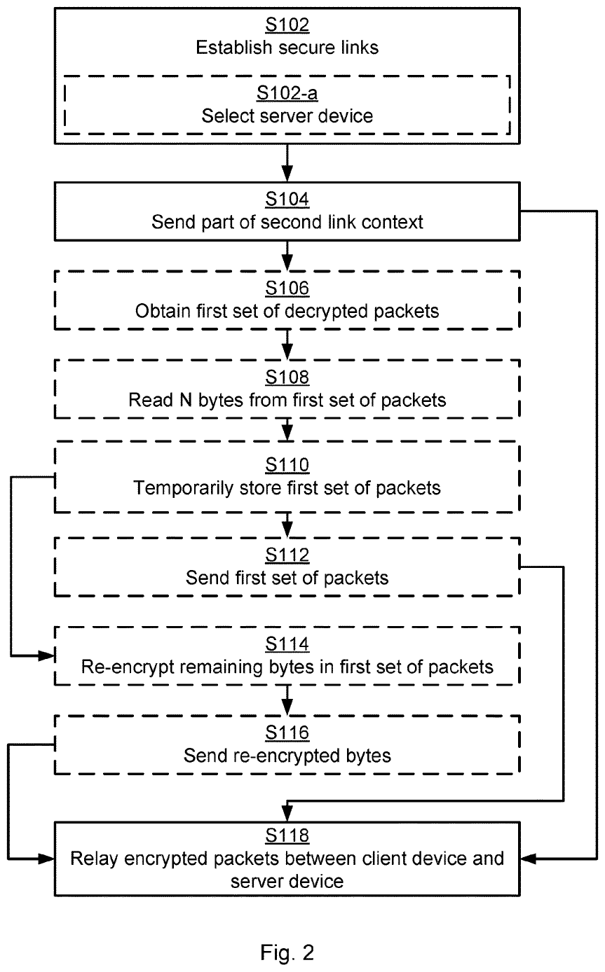

Reference is now made to FIG. 2 illustrating a method for secure communication between a client device 100 and a server device 300 as performed by the gateway 200 according to an embodiment. The gateway 200 is operatively connected between the client device 100 and the server device 300.

S102: The gateway 200 establishes a first secure link L12 with the client device 100 at a first socket and a second secure link L34 with the server device 300 at a second socket. The gateway 200 holds a second link context E2 for the first secure link L12 at the first socket and a third link context E3 for the second secure link L34 at the second socket.

After the gateway 200 has established both secure links L12 and L34, the gateway sends the part of the link context E2 to the server device 300.

S104: The gateway 200 sends a part of the second link context E2 to the server device 300 over the second secure link L34.

As will be further disclosed below, the server device 300 then replaces the corresponding part of its own link context E4 with the received link context E2. The gateway can then relay encrypted packets between E2.socket and E3.socket, while the rest of the link contexts E2 and E3 can be deleted.

S118: The gateway 200 relays encrypted packets between the client device 100 and the server device 300 without decrypting or encrypting the encrypted packets at the first socket or the second socket.

Embodiments relating to further details of secure communication between a client device 100 and a server device 300 as performed by the gateway 200 will now be disclosed with continued reference to FIG. 2.

There may be different types of secure links L12 and L34. As disclosed above, each of the first secure link L12 and the second secure link L34 could be a respective TLS link. However, as also disclosed above, also other protocols, such as QUIC can be used. Thus, alternatively, each of the first secure link L12 and the second secure link L34 is a respective QUIC link. Below, TLS is used as an example, but any reference to TLS could alternatively be replaced by a reference to QUIC.

There may be different types of link contexts Ek, where k=1, 2, 3, 4. In general terms, each link context specifies, defines, or at least comprises a context for data decryption of incoming packets and encryption of outgoing packets. That is, in some embodiments, the second link context E2 comprises a context for decrypting incoming packets and encrypting outgoing packets on the first secure link L12, and the third link context E3 comprises a context for decrypting incoming packets and encrypting outgoing packets on the second secure link L34. Further details of the link contexts Ek will be disclosed below.

In some aspects, the client device 100 requests access to a service run by at least one of the server devices. The gateway 200 might then select the service point, as defined by one of the available server devices, to which the second secure link L34 is to be established. Particularly, in some embodiments, the gateway 200 is configured to perform (optional) action S102-a as part of S102.

S102-a: The gateway 200, between establishing the first secure link L12 and establishing the second secure link L34, selects the server device 300 from a set of server devices 300.

One criterion for the selection is that the server device 300 needs to run the service to which the client device 100 requests access. Another, optional, criterion, for the selection could be to achieve load balancing. The latter requires that more than one server device is available and is running the service to which the client device 100 requests access.

Further, in some aspects, the gateway 200 has access to a list of services and server devices capable of running these services, and where among other things the list specifies whether or not a given server device supports having part of its link context being replaced. Therefore, in some embodiments, the set of server devices 300 includes only server devices 300 that support replacing part of their own security link context E4 for the second secure link L34 with the part of the second link context E2 belonging to the gateway 200.

Further in this respect, as part of establishing the first secure link L12, the gateway 200 might read the first N bytes as received from the client device 100 to determine the destination service point, and thus to find the correct server device among the set of server devices. Therefore, in some embodiments, the gateway 200 is configured to perform (optional) actions S106 and S108.

S106: The gateway 200 obtains a first set of decrypted packets by decrypting a first set of encrypted packets as received from the client device 100 over the first secure link L12.

S108: The gateway 200 reads N bytes from the first set of decrypted packets. The N bytes indicate which server device 300 to select from the set of server devices 300.

In some aspects, the gateway 200 also collects the corresponding raw TLS packets for future use. That is, in some embodiments, the gateway 200 is configured to perform (optional) action S110.

S110: The gateway 200 temporarily stores the first set of encrypted packets until determining either to send the first set of encrypted packets to the server device 300 over the second secure link L34 or to drop the first set of encrypted packets.

In case the gateway determines to send the first set of encrypted packets to the server device 300 over the second secure link L34, the first set of encrypted packets might be sent using the raw socket E3.socket. Therefore, in some embodiments, the gateway 200 is configured to perform (optional) action S112.

S112: The gateway 200 sends the first set of encrypted packets to the server device 300 over the second secure link L34.

In cases the gateway 200 must drop the first N bytes, and does not send them to the server device 300 in S112, then the gateway 200 might re-encrypt the remaining bytes of the last TLS packet, if there are any left, and send them to the server device 300 as the first TLS packet, before relaying encrypted packets, as in S118. Therefore, in some embodiments, the gateway 200 is configured to perform (optional) actions S114 and S116, in case the N bytes from the first set of decrypted packets are dropped.

S114: The gateway 200 re-encrypts any remaining bytes in the first set of decrypted packets; and

S116: The gateway 200 sends the re-encrypting bytes in a first packet to the server device 300 over the second secure link L34.

In general terms, each link context Ek, where k=1, 2, 3, 4 might comprise at least the following fields. Ek.socket is the standard socket that is associated with the physical network link, on top of which there is a TLS context in Ek. Ek.TLSver specifies supported TLS versions, which among other things dictates the structure of raw TLS packets. Ek. ALG specifies the algorithm, as agreed as the result of the handshake procedure, that is used to encrypt/decrypt TLS packets. Ek.KeyIv specifies the secret key and initialization vector (can also be called a Nonce or Counter) that was configured after the handshake procedure for the encryption/decrypt of the TLS packets with the algorithm Ek.ALG. There could be different KeyIv values for sending and receiving TLS packets. Ek. * represents any additional specifications, parameters, data, or information, and might, for example, comprise public/private keys for the purpose of the handshake procedure, configured certificates, expanded secret keys, precomputed values, finite state machine, I/O buffers, etc. In some aspects, the sent context specifies TLSver=protocol version, ALG, KeyIV. That is, in some embodiments, the part of the second link context E2 sent to the server device 300 specifies the protocol version for the first secure link L12, the encryption algorithm for the first secure link L12, the key(s) and the initialization vector(s) for the first secure link L12. In some aspects, the sent context includes all parts except the socket. That is, in some embodiments, the part of the second link context E2 sent to the server device 300 specifies the complete second link context E2 except the socket specification.

In general terms, the protocol version and the encryption algorithm for the first secure link L12 needs to be the same as the protocol version and the encryption algorithm for the second secure link L34, after the replacement of the E4 context with the partial or full (except for E2.socket) context from E2. In other words, with further respect to the link context, the protocol version and the encryption algorithm for the second link context E2 needs to be supported by the server device 300. Therefore, in some embodiments, the first secure link L12 is associated with a protocol version and an encryption algorithm, and, before sending the part of the second link context E2 to the server device 300, the gateway 200 verifies that the server device 300 supports the protocol version and the encryption algorithm.

Further in this respect, the gateway 200 might allow different client devices to utilize one of a multiple TLS versions and multiple ALG profiles. In order to support this, the gateway 200 might needs to configure the link context E3 to only allow E2.TLSver and E2.ALG before the gateway 200 establishes the secure link L34 to the server device 300. In some embodiments, the third link context E3 is therefore configured for the second secure link L34 to also be associated with the same protocol version and the same encryption algorithm. In this way, the server device 300 is forced to use a certain profile that was agreed for the first link L12 during the first handshake procedure.

In some embodiments, the part of the second link context E2 only is sent upon the gateway 200 having verified that the server device 300 supports replacing part of its own security link context E4 for the second secure link L34 with the part of the second link context E2 belonging to the gateway 200. A verification that the server device 300 supports replacing part of its own security link context E4 for the second secure link L34 with the part of the second link context E2 belonging to the gateway 200 can be achieved by the gateway 200 sending a dummy integer, or an empty code or request, to the server device 300 and expecting a certain message, or value, to be sent in return from the server device 300 in case the server device 300 supports the replacing as described above. In case the server device 300 does not support the replacing as described above, the gateway 200 might fall back to a legacy protocol, not involving the herein disclosed replacement of part of the security link context. Legacy and non-legacy server devices may be assigned with distinct listening ports, and by this it may be detected by the gateway 200 by trying first a non-legacy port, then if it fails then fallback and use the legacy port of the server device.

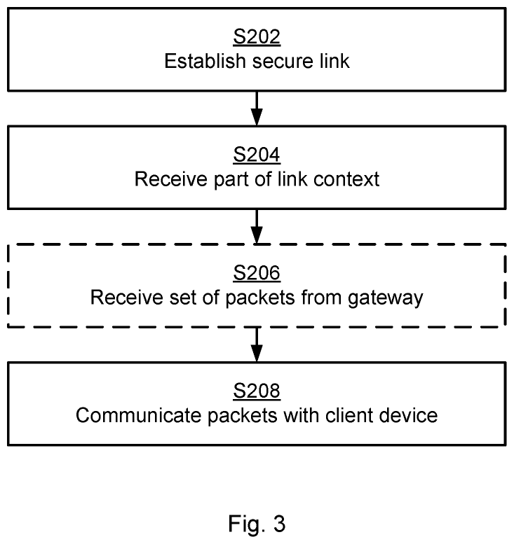

Reference is now made to FIG. 3 illustrating a method for secure communication between a client device 100 and a server device 300 as performed by the server device 300 according to an embodiment. The server device 300 is operatively connected to the gateway 200.

S202: The server device 300 establishes a second secure link L34 with the gateway 200. The server device 300 holds a fourth link context E4 for the second secure link L34.

S204: The server device 300 receives, from the gateway 200 and over the second secure link L34, a part of a second link context E2 for a first secure link L12 established between the gateway 200 and the client device 100.

S208: The server device 300 communicates packets with the client device 100 over the second secure link L34 with the received part of the second link context E2 replacing a matching part of the fourth link context E4 for encrypting and decrypting the packets (and switching the protocol type to E2.TLSver, if needed).

Embodiments relating to further details of secure communication between a client device 100 and a server device 300 as performed by the server device 300 will now be disclosed with continued reference to FIG. 3.

As disclosed above, there may be different types of secure links L12 and L34. As further disclosed above, each of the first secure link L12 and the second secure link L34 might be a respective TLS link or a respective QUIC link.

As disclosed above, in general terms, each link context specifies, defines, or at least comprises a context for data decryption of incoming packets and encryption of outgoing packets. That is, in some embodiments, the second link context E2 comprises a context for decrypting incoming packets and encrypting outgoing packets on a first secure link L12 established between the gateway 200 and the client device 100, and the third link context E3 comprises a context for decrypting incoming packets and encrypting outgoing packets on the second secure link L34.

As disclosed above, the gateway 200 in some embodiments (as in optional action S112) sends a first set of encrypted packets to the server device 300 over the second secure link L34. Therefore, in some embodiments, server device 300 is configured to perform (optional) action S206.

S206: The server device 300 receives a first set of encrypted packets from the gateway 200 over the second secure link L34 before communicating packets with the client device 100 over the second secure link L34. The first set of encrypted packets is, by the server device 300, decrypted using the part of the second link context E2 for the first secure link L12.

As disclosed above, in some aspects, the sent context specifies TLSver=protocol version, ALG, KeyIV. That is, in some embodiments, the part of the second link context E2 received from the gateway 200 specifies the protocol version for the first secure link L12, the encryption algorithm for the first secure link L12, and the key initialization vector for the first secure link L12. As disclosed above, in some aspects, the sent context includes all parts except the socket. That is, in some embodiments, the part of the second link context E2 received from the gateway 200 specifies the complete second link context E2 except socket specification.

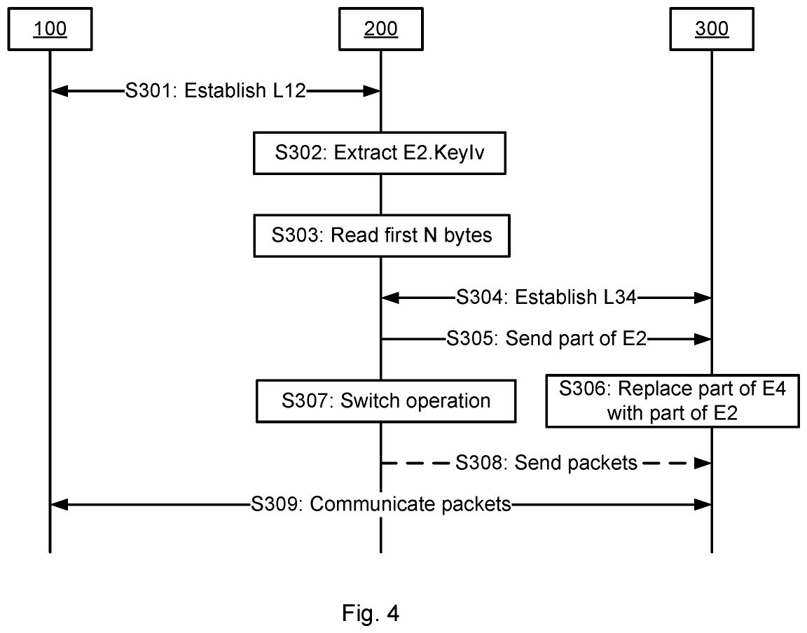

One particular embodiment for secure communication between a client device 100 and a server device 300 based on at least some of the above disclosed embodiments will now be disclosed in detail with reference to the signalling diagram of FIG. 4. In this embodiment, the gateway 300 is configured to only allow a certain TLS version and a certain ALG for the channel encryption, for both links L12 and L34. After the first handshake procedure between the client device 100 and the gateway 200, the TLS state Ex does not contain any unprocessed or partially processed TLS packets in its I/O buffer; e.g. it receives the next TLS packet only when an implicit TLS_read(Ex, . . . ) function is called and more bytes are requested to be read from the channel.

S301: The gateway 200 establishes a first secure link L12 with the client device 100 at a first socket.

S302: The gateway 200 extracts E2.KeyIv.

S303: The gateway 200 reads the first N bytes received from the client device 100 by decrypting the first X raw TLS packets. The gateway 200 also collects those received raw TLS packets for future use. In one example, the future use involves further direct transport to the server device 300. In one example, the future use involves using an adaption procedure where some of the original bytes are removed. In one example, the future use involves disregard these bytes.

S304: The gateway 200 establishes a second secure link L34 with the server device 300 at a second socket, possibly after having selected the server device 300 from a set of server devices 300.

S305: The gateway 200 sends a part of the second link context E2 to the server device 300 over the second secure link L34.

S306: The server device 300 holds a fourth link context E4 for the second secure link L34. The server device 300 now replaces the matching part of the fourth link context E4 with the part of the second link context E2 received from the gateway 200 in S305 for encrypting and decrypting packets to be communicated with the client device 100.

S307: The gateway 200 switches operation from using the complete second link context E2 and the complete third link context E3 to using only the sockets E2.sockets and E3.sockets.

S308 (optional): The gateway 200, depending on which option is selected in S303, sends the temporarily stored TLS packets to the server device 300 by using the raw socket E3.socket. The sever device 300 decrypts the relayed first X packets with its updated E4 context by using normal TLS_read() functionality. Depending on the scenario at hand, the server device 300 might simply ignore the first N bytes that were needed for the gateway to select the correct server device 300.

S309: The server device 300 communicates packets with the client device 100. For communication over the second secure link L34 the server device 300 uses the received part of the second link context E2 for encrypting and decrypting the packets. The gateway 200 relays encrypted packets between the client device 100 and the server device 300 without decrypting or encrypting the encrypted packets at the first socket or the second socket.

The embodiment in FIG. 4 is described without the support of a re-handshake procedure in the middle of the session. For example, TLS 1.2 allows re-handshake but TLS 1.3 does not. In the former case, any secure link just becomes invalidated if a re-handshake call is invoked in the middle of the session, and then the client device 100 needs to complete a reconnection procedure. For a re-handshake procedure in the middle of the session to be supported, the gateway 200 needs to provide at least some portions of the E2. * part, for example comprising any secrets that are associated with the authorization process.

In some aspects, the TLS library(s) that is/are used by the gateway 200 and the server device 100 need(s) to implement functions as “export” and “import” for the part of the second link context E2 to not only be sent from the gateway 200 to the server device 300 but also be used by the server device 300. This can be achieved in different ways. According to a first example, corresponding functions are added to the sources of the TLS library (e.g. OpenSSL) and so that custom binaries of the library can be built. According to a second example, the needed data structures can be extracted from open sources of the library and then provide plugin binaries (such as a separate extra-lib), with those two functions for extracting and inserting the needed secrets and other values. According to a third example, existing binaries and existing APIs are used in combination with some procedure to determine the location, or the memory offset, of the needed data field of E2/E4 from the starting address of the context E2/E4 (or from some inner pointer of E2/E4, for which yet another address offset is needed).

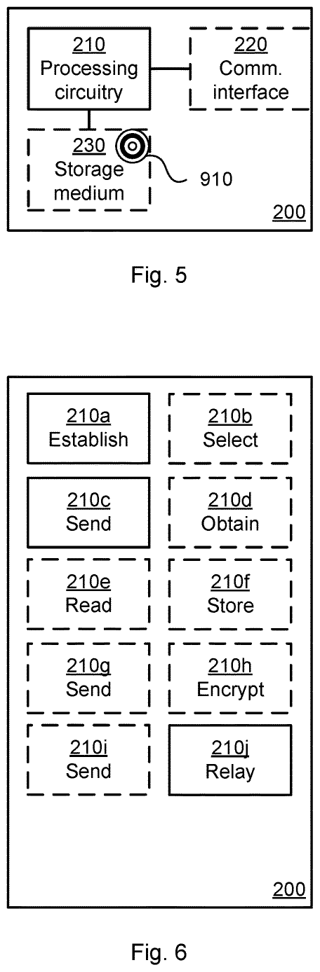

FIG. 5 schematically illustrates, in terms of a number of functional units, the components of a gateway 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910a (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the gateway 200 to perform a set of operations, or steps, as disclosed above. For example, the storage medium 230 may store the set of operations, and the processing circuitry 210 may be configured to retrieve the set of operations from the storage medium 230 to cause the gateway 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The gateway 200 may further comprise a communications (comm.) interface 220 for communications with other entities, functions, nodes, and devices, as illustrated in FIG. 1. As such the communications interface 220 may comprise one or more transmitters and receivers, comprising analogue and digital components.

The processing circuitry 210 controls the general operation of the gateway 200 e.g. by sending data and control signals to the communications interface 220 and the storage medium 230, by receiving data and reports from the communications interface 220, and by retrieving data and instructions from the storage medium 230. Other components, as well as the related functionality, of the gateway 200 are omitted in order not to obscure the concepts presented herein.

FIG. 6 schematically illustrates, in terms of a number of functional modules, the components of a gateway 200 according to an embodiment. The gateway 200 of FIG. 6 comprises a number of functional modules; an establish module 210a configured to perform step S102, a send module 210c configured to perform step S104, and a relay module 210j configured to perform step S118. The gateway 200 of FIG. 6 may further comprise a number of optional functional modules, such as any of a select module 210b configured to perform step S102-a, an obtain module 210d configured to perform step S106, a read module 210e configured to perform step S108, a store module 21of configured to perform step S110, a send module 210g configured to perform step S112, an encrypt module 210h configured to perform step S114, and a send module 210i configured to perform step S116. In general terms, each functional module 210a:210j may be implemented in hardware or in software. Preferably, one or more or all functional modules 210a:210j may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210j and to execute these instructions, thereby performing any steps of the gateway 200 as disclosed herein.

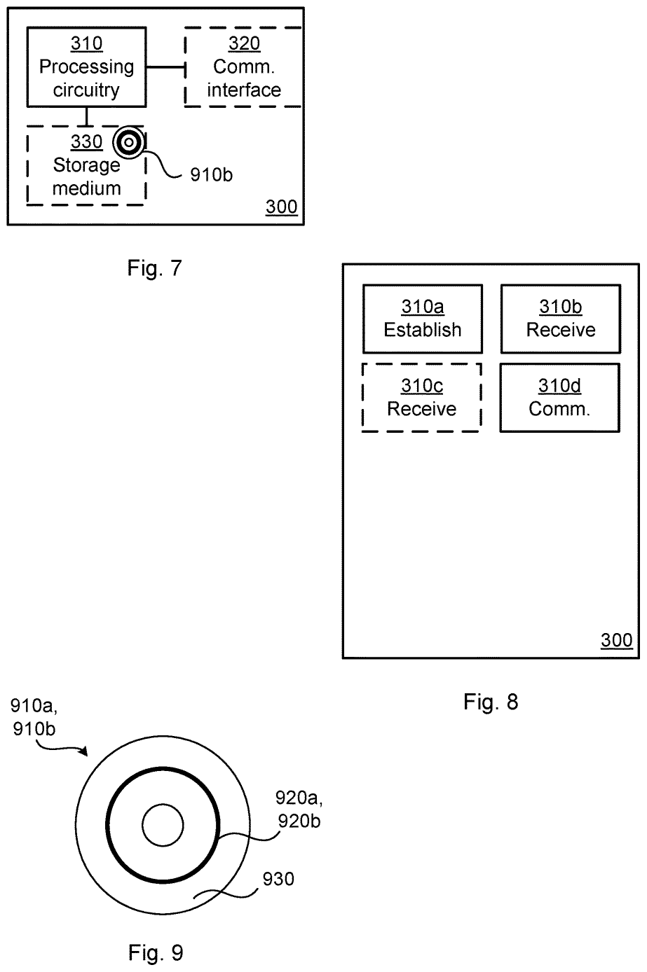

FIG. 7 schematically illustrates, in terms of a number of functional units, the components of a server device 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910b (as in FIG. 9), e.g. in the form of a storage medium 330. The processing circuitry 310 may further be provided as at least one application specific integrated circuit (ASIC), or field programmable gate array (FPGA).

Particularly, the processing circuitry 310 is configured to cause the server device 300 to perform a set of operations, or steps, as disclosed above. For example, the storage medium 330 may store the set of operations, and the processing circuitry 310 may be configured to retrieve the set of operations from the storage medium 330 to cause the server device 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The server device 300 may further comprise a communications interface 320 for communications with other entities, functions, nodes, and devices, as illustrated in FIG. 1. As such the communications interface 320 may comprise one or more transmitters and receivers, comprising analogue and digital components.

The processing circuitry 310 controls the general operation of the server device 300 e.g. by sending data and control signals to the communications interface 320 and the storage medium 330, by receiving data and reports from the communications interface 320, and by retrieving data and instructions from the storage medium 330. Other components, as well as the related functionality, of the server device 300 are omitted in order not to obscure the concepts presented herein.

FIG. 8 schematically illustrates, in terms of a number of functional modules, the components of a server device 300 according to an embodiment. The server device 300 of FIG. 8 comprises a number of functional modules; an establish module 310a configured to perform step S202, a receive module 310b configured to perform step S304, and a communicate module 310d configured to perform step S208. The server device 300 of FIG. 8 may further comprise a number of optional functional modules, such as a receive module 310c configured to perform step S206. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the server device 300 as disclosed herein.

The server device 300 may be provided as a standalone device or as a part of at least one further device. Thus, a first portion of the instructions performed by the server device 300 may be executed in a first device, and a second portion of the instructions performed by the server device 300 may be executed in a second device; the herein disclosed embodiments are not limited to any particular number of devices on which the instructions performed by the server device 300 may be executed. Hence, the methods according to the herein disclosed embodiments are suitable to be performed by a server device 300 residing in a cloud computational environment. Therefore, although a single processing circuitry 310 is illustrated in FIG. 7 the processing circuitry 310 may be distributed among a plurality of devices, or nodes. The same applies to the functional modules 310a:310d of FIG. 8 and the computer program 920b of FIG. 9.

FIG. 9 shows one example of a computer program product 910a, 910b comprising computer readable means 930. On this computer readable means 930, a computer program 920a can be stored, which computer program 920a can cause the processing circuitry 210 and thereto operatively coupled entities and devices, such as the communications interface 220 and the storage medium 230, to execute methods according to embodiments described herein. The computer program 920a and/or computer program product 910a may thus provide means for performing any steps of the gateway 200 as herein disclosed. On this computer readable means 930, a computer program 920b can be stored, which computer program 920b can cause the processing circuitry 310 and thereto operatively coupled entities and devices, such as the communications interface 320 and the storage medium 330, to execute methods according to embodiments described herein. The computer program 920b and/or computer program product 910b may thus provide means for performing any steps of the server device 300 as herein disclosed.

In the example of FIG. 9, the computer program product 910a, 910b is illustrated as an optical disc, such as a CD (compact disc) or a DVD (digital versatile disc) or a Blu-Ray disc. The computer program product 910a, 910b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920a, 920b is here schematically shown as a track on the depicted optical disk, the computer program 920a, 920b can be stored in any way which is suitable for the computer program product 910a, 910b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-29. (canceled)

30. A method for secure communication between a client device and a server device, the method being performed by a gateway, the gateway being operatively connected between the client device and the server device, the method comprising:
establishing a first secure link with the client device at a first socket and a second secure link with the server device at a second socket, wherein the gateway holds a second link context for the first secure link at the first socket and a third link context for the second secure link at the second socket;
sending a part of the second link context to the server device over the second secure link; and
relaying encrypted packets between the client device and the server device without decrypting or encrypting the encrypted packets at the first socket or the second socket.

31. The method according to claim 30, wherein the second link context comprises a context for decrypting incoming packets and encrypting outgoing packets on the first secure link, and wherein the third link context comprises a context for decrypting incoming packets and encrypting outgoing packets on the second secure link.

32. The method according to claim 30, wherein the method further comprises:
selecting the server device from a set of server devices between establishing the first secure link and establishing the second secure link.

33. The method according to claim 32, wherein the set of server devices includes only server devices that support replacing part of their own security link context for the second secure link with the part of the second link context belonging to the gateway.

34. The method according to claim 32, wherein the method further comprises:
obtaining a first set of decrypted packets by decrypting a first set of encrypted packets as received from the client device over the first secure link; and
reading N bytes from the first set of decrypted packets, wherein said N bytes indicates which server device to select from the set of server devices.

35. The method according to claim 30, wherein the first secure link is associated with a protocol version and an encryption algorithm, and wherein:
before sending the part of the second link context to the server device, the gateway verifies that the server device supports the protocol version and the encryption algorithm; and/or
the third link context is configured for the second secure link to also be associated with said protocol version and said encryption algorithm.

36. The method according to claim 30, wherein the part of the second link context only is sent upon the gateway having verified that the server device supports replacing part of its own security link context for the second secure link with the part of the second link context belonging to the gateway.

37. The method according to claim 30, wherein the part of the second link context sent to the server device specifies:
protocol version for the first secure link, encryption algorithm for the first secure link, and key initialization vector for the first secure link; or
the complete second link context except socket specification.

38. The method according to claim 30, wherein each of the first secure link and the second secure link is a TLS link, or wherein each of the first secure link and the second secure link is a QUIC link.

39. A gateway for secure communication between a client device and a server device, the gateway being configured to be operatively connected between the client device and the server device, the gateway comprising processing circuitry, the processing circuitry being configured to cause the gateway to:
establish a first secure link with the client device at a first socket and a second secure link with the server device at a second socket, wherein the gateway holds a second link context for the first secure link at the first socket and a third link context for the second secure link at the second socket;
send a part of the second link context to the server device over the second secure link; and
relay encrypted packets between the client device and the server device without decrypting or encrypting the encrypted packets at the first socket or the second socket.

40. The gateway according to claim 39, wherein the second link context comprises a context for decrypting incoming packets and encrypting outgoing packets on the first secure link, and wherein the third link context comprises a context for decrypting incoming packets and encrypting outgoing packets on the second secure link.

41. The gateway according to claim 39, the processing circuitry being further configured to cause the gateway to select the server device from a set of server devices between establishing the first secure link and establishing the second secure link.

42. The gateway according to claim 41, wherein the set of server devices includes only server devices that support replacing part of their own security link context for the second secure link with the part of the second link context belonging to the gateway.

43. The gateway according to claim 41, the processing circuitry being further configured to cause the gateway to:
obtain a first set of decrypted packets by decrypting a first set of encrypted packets as received from the client device over the first secure link; and
read N bytes from the first set of decrypted packets, wherein said N bytes indicates which server device to select from the set of server devices.

44. The gateway according to claim 39, wherein the first secure link is associated with a protocol version and an encryption algorithm, and wherein:
the processing circuitry is configured to cause the gateway to, before sending the part of the second link context to the server device, verify that the server device supports the protocol version and the encryption algorithm; and/or
the third link context is configured for the second secure link to also be associated with said protocol version and said encryption algorithm.

45. The gateway according to claim 39, the processing circuitry being configured to cause the gateway to only send the part of the second link context upon the gateway having verified that the server device supports replacing part of its own security link context for the second secure link with the part of the second link context belonging to the gateway.

46. The gateway according to claim 39, wherein the part of the second link context sent to the server device specifies:
protocol version for the first secure link, encryption algorithm for the first secure link, and key initialization vector for the first secure link; or
the complete second link context except socket specification.

47. The gateway according to claim 39, wherein each of the first secure link and the second secure link is a TLS link, or wherein each of the first secure link and the second secure link is a QUIC link.

48. A non-transitory computer-readable storage medium on which is stored a computer program for secure communication between a client device and a server device, wherein the computer program comprises computer code which, when run on processing circuitry of a gateway configured to be operatively connected between the client device and the server device, causes the gateway to:
establish a first secure link with the client device at a first socket and a second secure link with the server device at a second socket, wherein the gateway holds a second link context for the first secure link at the first socket and a third link context for the second secure link at the second socket;
send a part of the second link context to the server device over the second secure link; and
relay encrypted packets between the client device and the server device without decrypting or encrypting the encrypted packets at the first socket or the second socket.
